(19) United States
(12) Patent Application Publication
(10) Pub. No.: US 2013/0007807 A1
(43) Pub. Date: Jan. 3, 2013

(54) BLENDED SEARCH FOR NEXT GENERATION TELEVISION

(76) Inventors: Delia Grenville, Portland, OR (US); Kevin Putnam, Portland, CA (US); Ashwini Asokan, San Jose, CA (US)

(21) Appl. No.: 13/173,362

(22) Filed: Jun. 30, 2011

(51) Int. Cl. H04N 5/445

(52) U.S. Cl. 725/44

(57) ABSTRACT

Systems, devices and methods are disclosed for obtaining relevant content in response to metadata associated with video content being viewed on a display screen and for configuring the relevant content for display on the display screen. The relevant content may be configured in response to one or more relevance vectors specifying at least in part a position of the relevant content within a user interface.

### BACKGROUND

As the ability to access the Internet on television (TV) continues to expand, viewers will expect to be able to search data that enhances the content they enjoy on TV. However, conventional search engines return results that point users to complex text and visual search lists that may be difficult to navigate on the TV. In addition, many of the current search experiences do not facilitate searching for content while engaged in another activity, such as watching TV shows or movies.

Personal Computer (PC)-based browsers functioning on TVs or other consumer electronic (CE) devices may allow consumers to use the same search engines capabilities already available for PCs. However, such PC-based browsers may be sub-optimal because of font size, point and click dependency versus optimized interaction for remote controls, difficulty locating hyperlinks, etc. Some consumers may use additional devices such as a PC, cell phone, etc. to view information on the Internet while watching a TV show. However, conventional Internet-on-TV applications do not provide comprehensive search functionality similar to open web browsing. Instead, consumers often may only search within a specific application.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example system;

FIG. 2 illustrates an example process;

FIG. 3 illustrates an example process;

FIG. 4 is an illustrative diagram of an example media guide; and

FIG. 5 is an illustrative diagram of an example system, all arranged in accordance with at least some implementations of the present disclosure.

### DETAILED DESCRIPTION

One or more embodiments are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

In accordance with the present disclosure, a blended search format may be used to support the delivery of search results that are related to or in context with video content displayed on a display screen such as a TV. A blended search may provide search results adapted to conform to a TV's visual display format. Search results may be returned in response to a scene level context using digital content fingerprints and/or other metadata. Moreover, a blended search format may provide social media content related to a search. For instance, a Blended Search Media Guide (BSMG) as described herein may provide an Internet search framework and methodology in a TV context by allowing a consumer to seek information as well as engage with one or more social network(s) while consuming additional information about the program they are watching.

In accordance with the present disclosure, a blended search application may employ relevance vector algorithms to prioritize search result content for display on a display device such as a TV. For example, a blended search application may integrate digital content fingerprints and/or metadata tagging with search hit list creation. The application may then analyze and display search results in a user interface (UI) having a format suitable for display on a TV. The visual and/or logical layout of the search results may be optimized for viewing with other video content.

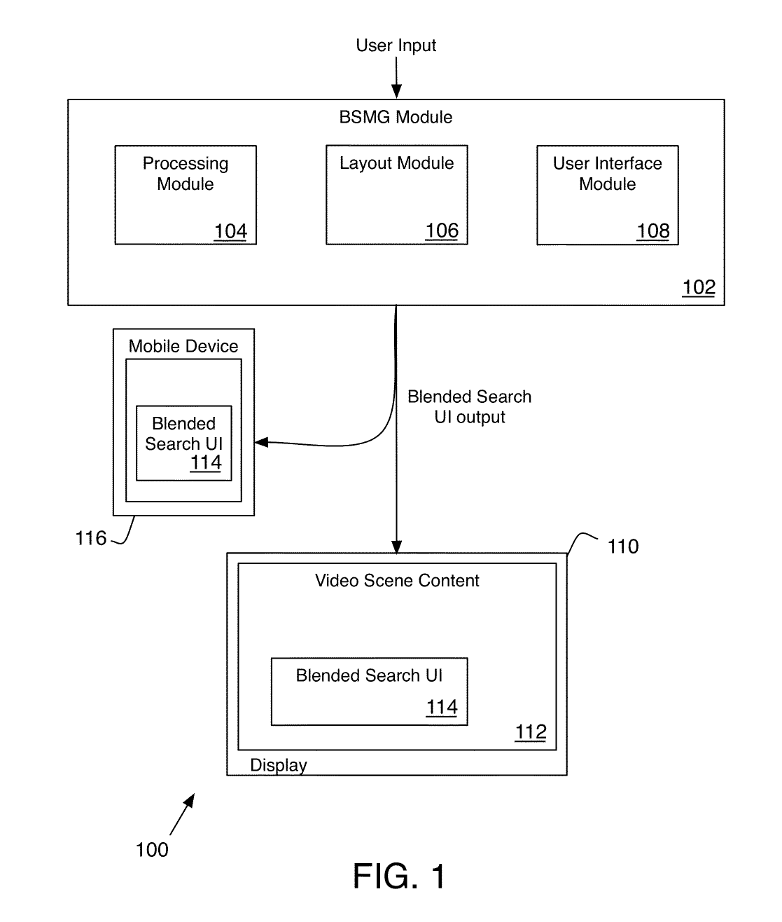

FIG. 1 illustrates a system 100 in accordance with the present disclosure. System 100 includes a BSMG module 102 communicatively and/or operably coupled to a display 110. BSMG module 102 includes a processing module 104, a layout module 106 and a user interface (UI) module 108. In various implementations, a user may be viewing video scene content 112 on display 110 where a content provider has provided content 112 for display to the user. In various implementations, display 110 may be any type of display device configured to display TV content. For example, display 110 may be a large-area flat panel TV display such as a plasma display panel (PDP) TV, a liquid crystal display (LCD) TV, and the like. In other non-limiting examples, display 110 may be a mobile computing device configured to display TV content such as a tablet computer, a smart phone, and so forth.

BSMG module 102 may be invoked in response to a user prompt. In various implementations, for example, a user may invoke BSMG module 102 by pressing one or more keys on a remote control (not shown) when viewing content 112 on display 110. In other example implementations, a user may invoke BSMG module 102 by using a gesture controlled remote to select a BSMG application, or by selecting a BSMG application icon and dragging the icon over a video content being viewed on a TV, and so forth. By invoking BSMG module 102, a user may initiate a search for content relevant or related to content 112 and that relevant content may be displayed in a blended search UI 114 as will be described in further detail below.

As will be explained in greater detail below, processing module 104 may search for relevant content on the Internet and/or other network destinations (e.g., a home network) in response to BSMG module 102 being invoked. The search may be open or may be filtered. For example, an open search may search for content across the entire Internet and/or all available network locations or addresses, while a filtered search may be limited to specific network locations and/or addresses such as particular websites. In various implementations, a user of system 100 and/or an entity that provides at least a portion of system 100 and/or an entity that provides or owns content 112 may determine the breadth of search conducted by module 104. For instance, a user may determine the breadth of search conducted by module 104 using, for example, a menu interface (not shown). In other examples, an entity making and/or selling BSMG module 102 and/or display 110, and/or an owner and/or provider of content 112 may determine the breadth of search conducted by module 104. The content searched for may be any type of media content available over a network including, but not limited to, video content, still image content, text content, content provided by social media websites, etc.

As will be explained in greater detail below, processing module 104 may utilize video scene information such as content metadata when searching for related content. Content metadata associated with a particular video scene may be information identifying relevant content for that scene. In response to the scene information, module 104 may create a search hit list specifying search criteria to be used in searching for relevant content. Content search criteria may include search terms, search locations, etc. Content metadata may include data such as content fingerprints and/or names, words or phrases associated with and/or derived from content 112. For example, metadata associated with content 112 may include a content fingerprint generated from content 112 using well-known content fingerprinting techniques. Processing module 104 may then provide the search results to layout module 106.

Layout module 106 may receive relevant content search results from processing module 104 and may reformat the relevant content for TV viewing using algorithms and/or instructions from metadata provided by, for example, the owner of content 112. As will be explained in greater detail below, layout module 106 may then present the final results list according to blended search layout engine algorithms and configurable relevance vectors. Metadata may be used to obtain Internet content from preferred sites that are TV-relevant, business model relevant, or open web (e.g., as may be determined by developer of system 100). Relevance data vectors may determine what order or locations the relevant content appears in UI 114.

Layout module 106 may provide the configured and/or formatted relevant content search results to UI module 108. UI module 108 may then use well-known techniques to display the search results within blended search UI 114. For example, UI module 108 may use well-known techniques to overlay UI 114 on/over video scene content 112 so that a user may view and/or interact with the relevant content search results while still viewing at least some of content 112. UI 114 may have any of a number of well-known UI formats including cover flow, 3D barrel, visual electronic programming guide (EPG), to name a few non-limiting examples. While UI 114 may be provided for viewing on display 110, UI 114 may also be provided for displaying on additional devices such as mobile device 116. In various implementations, device 116 may or may not also display content 112.

System 100 may be implemented in software, firmware, and/or hardware and/or any combination thereof. For example, various components of system 100 may be provided, at least in part, by software and/or firmware instructions executed by or within a computing system SoC such as a CE system. For instance, the functionality of BSMG module 102 as described herein may be provided, at least in part, by software and/or firmware instructions executed by one or more processor cores of a CE device such as a set-top box, an Internet capable TV, etc. In another example implementation, the functionality of BSMG module 102 as described herein may be provided, at least in part, by software and/or firmware instructions executed by one or more processor cores of a system that also provides display screen 110.

Further, the functionality of BSMG module 102 and/or the various modules 104, 106 and/or 108 of BSMG module 102 may be distributed among one or more devices. For example, in various implementations, the functionality of one or more of modules 104, 106 and/or 108 may be distributed among one or more devices remote to system 100 such as one or more remote servers and so forth. In addition, content 112 may appear on any device and is not limited to appearing on the example devices described herein such as tablet computers, TVs, smart phones and the like.

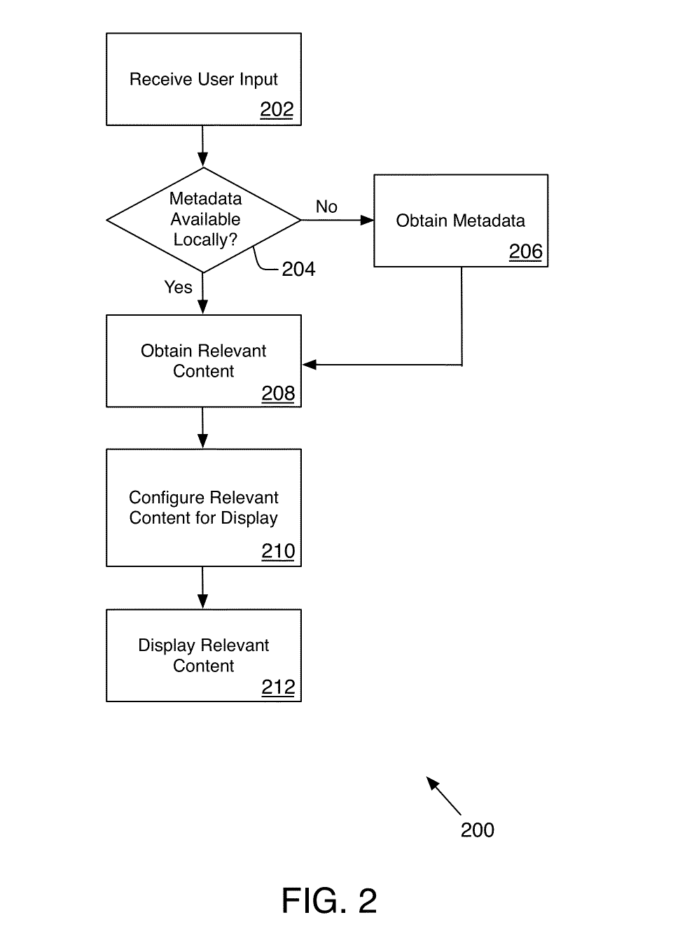

FIG. 2 illustrates a flow diagram of an example process 200 according to various implementations of the present disclosure. Process 200 may include one or more operations, functions and/or actions as illustrated by one or more of blocks 202, 204, 206, 208, 210 and 212. While, by way of non-limiting example, process 200 will be described herein in the context of example system 100 of FIG. 1, those skilled in the art will recognize that process 200 may be implemented in various other systems and/or devices. Process 200 may begin at block 202.

At block 202, a user input may be received. For example, BSMG module 102 may receive user input in the form of a search request generated by a user pressing a button on a remote control, selecting and dragging a BSMG application icon over content 112, or the like. In response to the user input, a determination may be made as to whether metadata is available locally (block 204). For instance, processing module 104 may determine whether metadata, such as a content fingerprint associated with content 112, is available locally to system 100. For example, system 100 may include an associated content fingerprint as at least a portion of side-band or non-video data accompanying content 112. If content metadata is available locally, processing module 104 may capture that metadata in undertaking block 204.

If, however, block 204 results in a determination that metadata is not available locally then, at block 206 metadata may be obtained from elsewhere. For instance, if processing module 104 determines at block 204 that content 112 does not contain or carry with it associated content metadata, then processing module 104 may obtain the metadata at block 206 by, for example, obtaining metadata related to content 112 from the Internet, and/or from a service provider EPG, to name a few non-limiting examples.

As noted above, the content metadata of blocks 204 and 206 may be any metadata specifying one or more attributes of the content being viewed on a TV display. For example, metadata in accordance with the present disclosure may be content fingerprint data generated using well-known techniques. For instance, a content fingerprint may be generated by technical analysis of content using one or more content analysis techniques such as, for example, facial recognition, voice pattern recognition, logo recognition, audio analysis, voice analysis, video attribute recognition, and so forth. Such technical analysis may result in a tagged output or one or more technical attributes for each piece of content. In some examples, a content fingerprint may be encrypted to form an encrypted packet of technical attributes. In such examples, blocks 204/206 may include decrypting one or more content fingerprints.

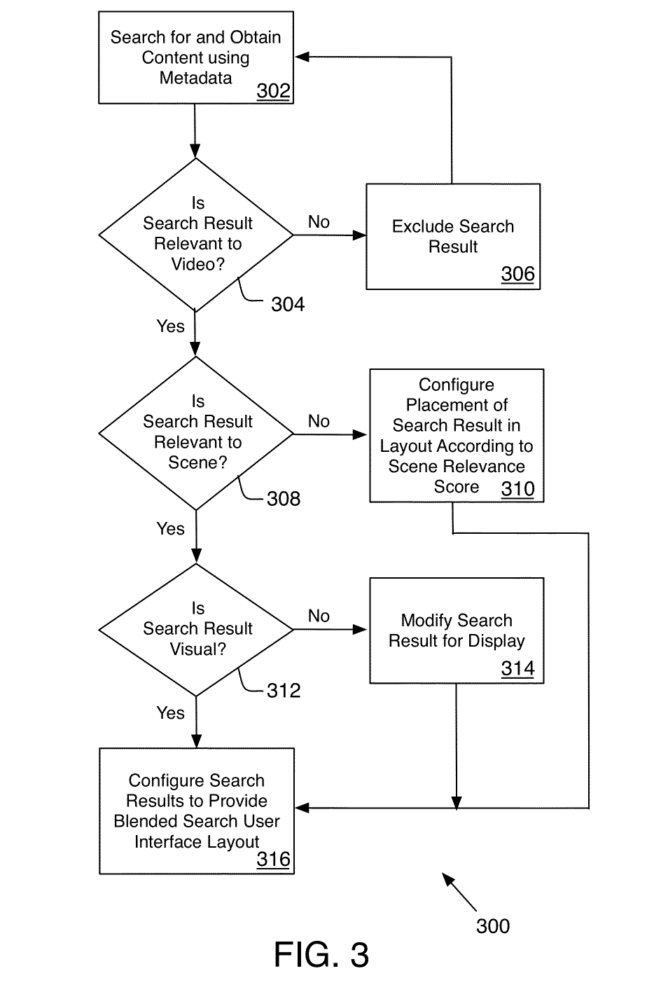

At blocks 208 and 210, relevant content may be obtained and then configured for display respectively. FIG. 3 illustrates a flow diagram of an example process 300 for undertaking blocks 208 and 210 of FIG. 2 according to various implementations of the present disclosure. Process 300 may include one or more operations, functions and/or actions as illustrated by one or more of blocks 302, 304, 306, 308, 310, 312, 314 and 316. While, by way of non-limiting example, process 300 will be described herein in the context of example system 100 of FIG. 1, those skilled in the art will recognize that process 300 may be implemented in various other systems and/or devices. Process 300 may begin at block 302.

At block 302, relevant content may be searched for and obtained using the metadata obtained in blocks 204/206 of process 200. For instance, if content 112 is a popular TV program, then metadata associated with content 112 may include, but would not be limited to, the name of the show and/or the name of the TV series the show is a part of, the names of the actors appearing in the show, topics of conversation appearing in the show, etc. In some implementations, content owners and/or providers may determine the information provided as content metadata. In undertaking block 302 the content metadata may be used to generate a list of search terms to be used to search the Internet or specific network locations such as specific websites that may be associated with a content owner's and/or provider's business model. The search may be conducted using any of a number of well-known content search techniques or utilities such as Internet search engines. In some implementations, undertaking block 302 may include searching one or more EPGs associated with the content being viewed.

Beginning at block 304 a series of determinations may be undertaken to characterize and/or classify the search results obtained at block 302. At block 304, for each piece of content obtained as a search result a determination may be made as to whether that search result or content is relevant to the video being watched. For instance, a determination may be made as to whether a search result, such as a website mentioning an actor's name, is relevant to content 112 on display 110. If the search result is determined to not be relevant then, at block 306 the search result may be excluded from incorporation into a BSMG layout. For instance, in various non-limiting examples, an owner of content 112 may exclude search results that include content such as websites provided by unauthorized content aggregators, websites that may contain offensive material, and so forth. In some implementations, a search result excluded at block 306 from inclusion in a BSMG layout may be provided for display in an EPG format. Once a result has been excluded at block 306, blocks 302 and 304 may be undertaken for a next search result.

If block 304 results in the determination that a search result is relevant to the video content being viewed, then, at block 308, a determination may be made as to whether the search result is relevant to the particular scene being viewed. In various implementations, the content of a search result may be provided with a scene relevance score at block 308. For instance, while a website's content may be considered relevant to the video content at block 304, that website's content may be determined to not be relevant to the scene being viewed and may be given a lower scene relevance score at block 308 than otherwise might be the case. Hence, in some implementations, block 308 may involve providing a scene relevance score for content. Such scene relevance scoring may range from binary relevant/not relevant scoring schemes to scoring schemes having more granularity such as scoring search result content on, for example, a scale from zero to one. Block 308 may then involve applying a threshold test to the search result's scene relevance score value.

If a search result is found to not be relevant at block 308 then the search result may be configured for placement in a BSMG layout at block 310 according to that search result's scene relevance score falling below a threshold relevance value and process 300 may continue to block 316. For example, as will be explained in greater detail below, a search result may be configured for placement in a BSMG layout in a manner that signifies that search result's relevance to a scene being viewed.

If, on the other hand, a search result is found to be relevant at block 308 then a determination may be made as to whether the search result content is visual (block 312). For instance, a search result may be considered visual if the search result is in the form of an image or a video sequence. If the search result is visual then process 300 may continue to block 316 where the search results may be blended with other search results to provide a BSMG layout. If, however, the search result is determined to be non-visual then the search result's content may be modified for display (block 314). For example, if a search result's content is in a textual format such as, for example, a Rich Text Format (RTF) format or such, then the content may be subjected to well-known text to image conversion techniques to modify the text content into a visual format such as a Device Independent Bitmap (DIB) format or the like.

In various implementations, as noted previously, relevance vectors may be used to determine relevance scores for search results in implementing blocks 304-310. For example, relevance vectors may be configurable and may specify preferred websites that are TV-relevant, business model relevant, open web, or the like (e.g., as may be determined by developer of system 100 and/or an owner or provider of content 112). In addition to determining which content appears in a blended search user interface or BSMG such as UI 114, relevance vectors may also, at block 316, be used to determine the placement of a particular search result content within in a blended search user interface. For example, a relevance vector may specify different placement for keyword based search results (e.g., obtained from EPGs, etc.), as compared to search results obtained from an Internet search engine or from specific websites (e.g., as specified by a developer of system 100 and/or an owner or provider of content 112).

At block 316, relevant content resulting from blocks 310, 312 and/or 314 may be configured or arranged to provide a layout for a blended search user interface. In various implementations, block 316 may involve providing a BSMG in the form of a blended search UI such as blended search UI 114 and, referring again to process 200 of FIG. 2, the relevant content may be displayed (block 212). For example, block 212 may involve displaying a BSMG in the form of a blended search UI.

Processes 200 and 300 set forth various functional blocks or actions that may be described as processing steps, functional operations, events and/or acts, etc. Those skilled in the art in light of the present disclosure will recognize that numerous alternatives to the functional blocks shown in FIGS. 2 and 3 may be practiced in various implementations. For example, although process 300, as shown in FIG. 2 includes one particular order of blocks or actions, the order in which these blocks or actions are presented does not necessarily limit the claimed subject matter to any particular order. Likewise, intervening actions not shown in FIGS. 2 and 3 and/or additional actions not shown in FIGS. 2 and 3 may be employed and/or some of the actions shown in FIGS. 2 and 3 may be eliminated, without departing from the scope of the claimed subject matter. Further, one or more devices and/or systems may provide for the functionality described herein for processes 200 and 300. For example, referring again to system 100 of FIG. 1, BSMG module 102 may undertake processes 200 and 300.

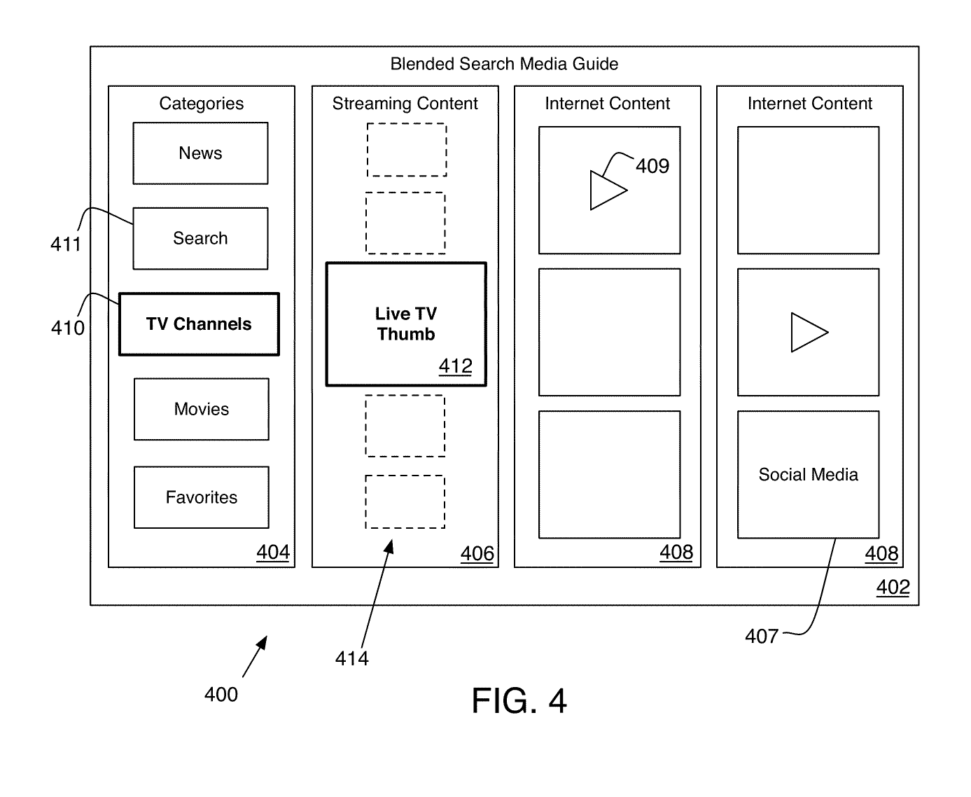

FIG. 4 illustrates a layout 400 of an example blended search UI or BSMG 402 according to various implementations of the present disclosure. Example BSMG 402 includes a categories section 404, a streaming content section 406, and Internet content sections 408. Streaming search result content may auto-play in streaming content section 406 when highlighted or selected by a user. Content played in streaming content section 406 may be streamed directly from the Internet or may be provided from local storage such as a digital video recorder (DVR). Internet content sections 408 may contain search result content such as video, photos, message boards, blogs, trivia websites, and the like. For instance, social media content 407 may be provided within sections 408. In some implementations, a user may interact with social media content 407 by, for example, sending to or receiving messages from a corresponding social media website providing relevant content 407. BSMG 402 may be provided in any user interface configuration such as cover flow, 3D barrel, visual electronic programming guide (EPG), to name a few non-limiting examples.

In various implementations, content appearing in sections 408 may be filtered based on search terms and/or by user selections of sections 404 and 406. In some implementations, text or keyword searches may be initiated from within BSMG 402 by user selection of, for example, a search portion 411. The resulting search may include searching content within BSMG 402 and/or content available externally over, for example, the Internet. Additionally, one or more icons 409 may indicate that associated search result content within BSMG 402 is video content and may be played by, for example, clicking on an icon 409. Further, in various implementations, a user may configure at least portions of layout 400.

As noted above, relevance vectors may determine the arrangement or positioning of search result content within layout 400. For example, a user interested in streaming TV content may select a corresponding portion 410 of categories section 404. This may cause streaming content to play or to be made available to play (e.g., when selected) in a first thumb region 412 of streaming content section 406. A relevance vector as described herein may specify that particular search result content is played or made available to play in first thumb region 412 in response to a user selecting portion 410 while other search result content is made available in second thumb regions 414 only if the user selects those thumb regions.

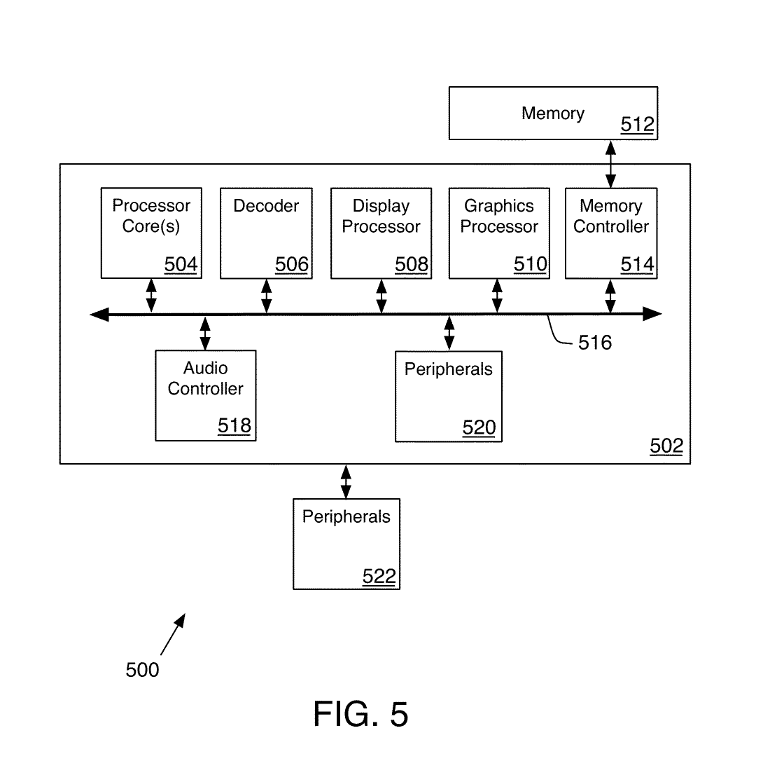

FIG. 5 illustrates an example system 500 in accordance with the present disclosure. System 500 may be used to perform some or all of the various functions discussed herein and may include one or more of the components of system 100. System 500 may include selected components of a computing platform or device such as a tablet computer, a smart phone, a set top box, etc., although the present disclosure is not limited in this regard. In some implementations, system 500 may be a computing platform or SoC based on Intel® architecture (IA) for consumer electronics (CE) devices. It will be readily appreciated by one of skill in the art that the implementations described herein can be used with alternative processing systems without departure from the scope of the present disclosure.

System 500 includes a processor 502 having one or more processor cores 504. In various implementations, processor core(s) 502 may be components of a 32-bit central processing unit (CPU). Processor cores 504 may be any type of processor logic capable at least in part of executing software and/or processing data signals. In various examples, processor cores 404 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor or microcontroller. Further, processor core(s) 504 may implement one or more of modules 104-108 of system 100 of FIG. 1.

Processor 502 also includes a decoder 506 that may be used for decoding instructions received by, e.g., a display processor 508 and/or a graphics processor 510, into control signals and/or microcode entry points. While illustrated in system 500 as components distinct from core(s) 504, those of skill in the art may recognize that one or more of core(s) 504 may implement decoder 506, display processor 508 and/or graphics processor 510.

Processing core(s) 504, decoder 506, display processor 508 and/or graphics processor 510 may be communicatively and/or operably coupled through a system interconnect 516 with each other and/or with various other system devices, which may include but are not limited to, for example, a memory controller 514, an audio controller 518 and/or peripherals 520. Peripherals 520 may include, for example, a unified serial bus (USB) host port, a Peripheral Component Interconnect (PCI) Express port, a Serial Peripheral Interface (SPI) interface, an expansion bus, and/or other peripherals. While FIG. 5 illustrates memory controller 514 as being coupled to decoder 506 and the processors 508 and 510 by interconnect 516, in various implementations, memory controller 514 may be directly coupled to decoder 506, display processor 508 and/or graphics processor 510.

In some implementations, system 500 may communicate with various I/O devices not shown in FIG. 5 via an I/O bus (also not shown). Such I/O devices may include but are not limited to, for example, a universal asynchronous receiver/transmitter (UART) device, a USB device, an I/O expansion interface or other I/O devices. In various implementations, system 500 may represent at least portions of a system for undertaking mobile, network and/or wireless communications.

System 500 may further include memory 512. Memory 512 may be one or more discrete memory components such as a dynamic random access memory (DRAM) device, a static random access memory (SRAM) device, flash memory device, or other memory devices. While FIG. 5 illustrates memory 512 as being external to processor 502, in various implementations, memory 512 may be internal to processor 502 or processor 502 may include additional, internal memory (not shown). Memory 512 may store instructions and/or data represented by data signals that may be executed by the processor 502. For example, memory 512 may store search result content obtained and/or used in processes 200 and 300. In some implementations, memory 512 may include a system memory portion and a display memory portion.

The systems described above, and the processing performed by them as described herein, may be implemented in hardware, firmware, or software, or any combination thereof. In addition, any one or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed:

1. A method, comprising:
at one or more processor cores,
obtaining relevant content in response to metadata, wherein the metadata is associated with video content being displayed on a display screen; and
configuring the relevant content for display on the display screen, wherein configuring the relevant content for display includes configuring the relevant content in response to one or more relevance vectors specifying at least in part a position of the relevant content within a user interface.

2. The method of claim 1, wherein the metadata comprises a content fingerprint.

3. The method of claim 1, further comprising:
displaying the relevant content on the display screen.

4. The method of claim 3, wherein displaying the relevant content on the display screen comprises displaying the relevant content in a media guide.

5. The method of claim 4, wherein the relevant content comprises social media content, and wherein the media guide is configured to permit the exchange of messages via one or more social media websites.

6. The method of claim 1, wherein obtaining the relevant content comprises obtaining the relevant content in response to the one or more relevance vectors.

7. The method of claim 6, wherein obtaining the relevant content comprises obtaining a plurality of search results in response to the metadata; and wherein obtaining the relevant content in response to the one or more relevance vectors comprises excluding one or more of the plurality of search results.

8. The method of claim 1, wherein the relevant content comprises text content, and wherein configuring the relevant content for display comprises converting the text content into image content.

9. A system, comprising:
one or more processor cores configured to obtain relevant content in response to metadata and to arrange the relevant content for display on a display screen; and
memory coupled to the one or more processor cores and configured to store the relevant content,
wherein the metadata is associated with video content to be displayed on the display screen, and
wherein the one or more processor cores are configured to arrange the relevant content for display on the display screen in response to one or more relevance vectors specifying at least in part a position of the relevant content within a user interface.

10. The system of claim 9, wherein the metadata comprises a content fingerprint.

11. The system of claim 9, wherein the one or more processor cores are further configured to display the relevant content on the display screen.

12. The system of claim 11, wherein the one or more processor cores are further configured to display the relevant content on the display screen by displaying the relevant content in a media guide.

13. The system of claim 12, wherein the relevant content comprises social media content, and wherein the media guide is configured to permit the exchange of messages via one or more social media websites.

14. The system of claim 9, wherein one or more processor cores are configured to obtain the relevant content in response to the one or more relevance vectors.

15. An article comprising a computer program product having stored therein instructions that, if executed, result in:
at one or more processor cores,
obtaining relevant content in response to metadata, wherein the metadata is associated with video content being displayed on a display screen; and
configuring the relevant content for display on the display screen, wherein configuring the relevant content for display includes configuring the relevant content in response to one or more relevance vectors specifying at least in part a position of the relevant content within a user interface.

16. The article of claim 15, wherein the metadata comprises a content fingerprint.

17. The article of claim 15, wherein instructions for configuring the relevant content for display on the display screen include instructions for displaying the relevant content in a media guide.

18. The article of claim 17, wherein the relevant content comprises social media content, and wherein the media guide is configured to permit the exchange of messages via one or more social media websites.

19. The article of claim 15, wherein instructions for obtaining the relevant content include instructions for obtaining the relevant content in response to the one or more relevance vectors.

20. The article of claim 19, wherein instructions for obtaining the relevant content include instructions for obtaining a plurality of search results in response to the metadata, and wherein instructions for obtaining the relevant content in response to the one or more relevance vectors include instructions for excluding one or more of the plurality of search results.
